(19) United States
(12) Patent Application Publication
(10) Pub. No.: US 2012/0271734 A1
(43) Pub. Date: Oct. 25, 2012

(54) System and method for executing consumer-definable events triggered by the purchasing of a code with a non-tangible computer generated product attached that is assigned to a geographic location coordinate

(76) Inventor: Jon Alan Van Fossan, Anderson, CA (US)

(21) Appl. No.: 13/425,427

(22) Filed: Mar. 21, 2012

Related U.S. Application Data
(60) Provisional application No. 61/516,179, filed on Mar. 31, 2011.

(51) Int. Cl. G06Q 30/06

(52) U.S. Cl. 705/26.9

(57) ABSTRACT

A method and system that is initiated by the producer of a computer generated interactive program that offers non-tangible computer generated product (1) that is attached to a code and sold to a consumer (2). The consumer of the code provides a geographic coordinate to the producer of the non-tangible computer generated product and places the purchased code at a geographic coordinate (4). The Producer of the non-tangible computer generated product provides the geographic coordinate to the user of a computer generated interactive program (3). The user of the computer generated interactive program actively seeks out the desired geographic coordinate to obtain the code with the non-tangible computer generated product attached. The user may enter the code into a computer generated interactive account and receive the non-tangible computer generated product (5). The consumer of the code may engage with the user of the computer generated interactive program while they are present at the geographic coordinate (6).

### Cross-Reference to Related Applications

This application claims the benefit of provisional patent application Ser. No. 61/516 179.Filed on 2011 Mar. 31 by the present inventor

The following is a tabulation of prior aft that presently appears relevant:

### U.S. Patent Application Publications

Publication Nr Kind Code Iissue Date Patentee

200810167129 A1 2008-7-10 Aaron/Ruckart

Suppliers of computer generated interactive programs commonly offer non-tangible computer generated products to the user of the computer generated interactive program. The computer generated product commonly comes in a form of a non-tangible object such as a sword, gun, sheep or statistical enhancements to the user's profile or account. The product is Commonly offered to a user of the computer generated interactive program by the act of interacting with the program.

Aaron and Ruckart disclose a method for the user of the computer generated interactive program to obtaining a non-tangible computer generated product by use of geocaching. The method of Using geocaching presented by Aaron and Ruckart is a way for the user of the computer'generated interactive program to obtain a desired non-tangible computer generated product by traveling to a geographic coordinate through the method of geocaching. Once the geographic coordinate has been found the user then may claim their computer generated non-tangible product by entering a code into their account or profile associated with a computer generated interactive prograrn. This method however suffers from three disadvantages:

(a) The method presented by Aaron and Ruckart doesn't clearly indicate how the supplier of a computer generated interactive program may profit when the user of the computer generate interactive program uses Geocaching to acquire a desired computer generated product. Therefore the method described by Aaron and Ruckart suffers from the disadvantage of Limiting its potential use by a supplier due to it not clearly indicating how a supplier may profit from its use.

(b) Aaron and Ruckart's method limits the user of the computer generated interactive program to using Geocaching as a way to acquire a desired computer generated product Geographical coordinates may also be located manually by map or by methods of communication_{—} By limiting, the user of the computer generated interactive program to Geocaching Aaron and Ruckart deprive additional methods for the user to locate a geographic coordinate thus potentially limiting its appeal to the user.

(c) Aaron and Ruckart's method supports an interaction between an established consumer and a supplier. Additional consumers, not associated with a computer generated account May potentially benefit by purchasing computer generated products.

### SUMMARY

In accordance with creating an additional consumer by providing a code that is attached to a non-tangible product and placed at a geographic location coordinate of the consumer's choice.

### Advantages

Accordingly the several advantages of this system and method are as follows: To create an additional consumer for a product introduced by the producers of computer generated interactive program that receives revenue from non-tangible computer generated products. To provide to the consumer of the code with an attached non-tangible computer generated product additional business opportunities through the interaction with a user who physically succeeded obtaining a codes at an assigned geographic location coordinate. To also provide to the user of the computer generated account the opportunity to acquire desired non-tangible computer generated product through the act of seeking, out a geographic location coordinate and acquiring said non-tangible computer generated product for free. To also provide to the user of computer generated interactive program an opportunity to be physically active and mobile. Advantages of the system and method will be apparent from consideration of the drawing and ensuing description.

### DRAWING—FIGURE

In the drawing, a visual is provided that clearly describe the system and method.

FIG. 1. Shows the system of interactions between the producer the consumers of the code that represents the purchase of an attached non-tangible computer generated product and the user of the computer generated program.

Drawing - Reference Numerals

| | | | |
|---|---|---|---|
| 1 | Producer | 2 | Consumer of code |
| 3 | User of computer interactive program | 4 | Placement of Code |
| 5 | Act of seeking out code and reward | | |
| | by locating geographic location coordinate | | |
| 6 | Consumer and user engagement | | |

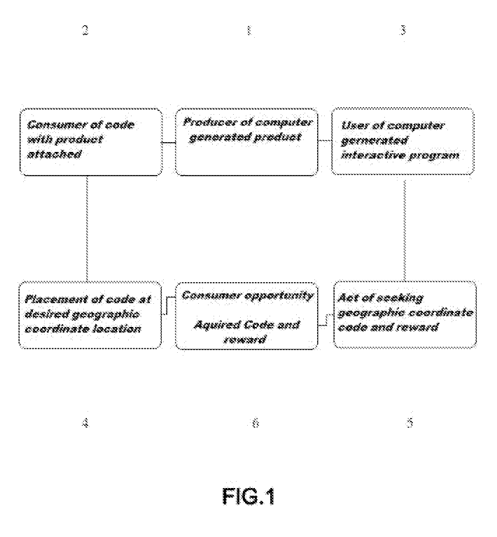

### DETAILED DESCRIPTION—FIG. 1—FIRST EMBODIMENT

The embodiment of FIG. 1 displays the system of interaction between the producer of the non-tangible computer generated product with the consumer of the code with a non-tangible computer generated product attached and the user of the computer generated interactive program.

Reference number 1 represents the producer of said non tangible computer generated product The producer initially interacts with the consumer represented in reference number 2. The producer then sells said non-tangible computer generated product to said consumer and is provided a code that represents the purchased non tangible computer generated product. The consumer represented in reference number 2 then provides to the producer in reference number 1 a geographic location coordinate that is agreed that said code will be placed.

The producer that is represented in reference number 1 then places the agreed geographic location coordinate in a computer generated interactive program that the user represented in reference number 3 interacts with, The producer of the non-tangible computer generated product who is represented in reference number 1 will communicate to the user represented in reference number 3 the geographic location coordinate and the non-tangible computer generated product that is placed at the location attached to a code.

Reference number 4 represents the act of the consumer initially represented in reference number 2 physically placing the said code at the said agreed geographic location with the non-tangible computer generated product attached.

Reference numbers represents the user initially represented in reference number 3 actively seeking the geographic location coordinate of the non-tangible computer generated product attached to a code placed at the geographic coordinate location.

Reference number 6 represents both consumer, represented in reference number 2, and the user of the computer generated interactive program represented in reference number 3 receiving both desired outcomes. The user represented in reference number 3 inputs the code into their computer generated interactive program thus receiving said non-tangible computer generated product. The consumer represented in reference number 2 receives their desired outcome by having the User represented in reference number 3 present at the geographic location coordinate of their choice.

### CONCLUSION, RAMIFICATIONS, AND SCOPE

Accordingly, the reader will see through the interaction with the provider both by the consumer and the user of the computer generated interactive program that a system of motivation and desire for a product is supported. The user of the computer interactive program is motivated by their desire to obtain a non-tangible computer generated product. The consumer of the code that places the code at a geographic location coordinate with a computer generated non-tangible product attached to is motivated by having the user of the computer generated interactive program physically at the desired geographic location, coordinate The advantages consist of:

(a) It creates an additional consumer of non-tangible computer generated products.

(b) It creates the opportunity for the consumer of the code that is placed at a geographic location coordinate attached to a non-tangible computer generated product to interact with the user of the computer generated interactive program that is physically present at the desired geographic location coordinate.

(c) It motivates the user of the Computer generated interactive program to physically move to obtain desired product thus creating the opportunity for improved health.

Although the description above contains specifics as to how the mode and system are performed. These should not be construed as limiting the scope of the embodiment of its function. For example the consumer of the code with an attached non-tangible computer generated products is not limited to entertainment based computer generated products. Non-tangible computer generated products may also be used for practical daily purpose.

Thus the scope of the embodiment should be determined by the appending claims and their legal equivalent, rather by the examples given.

### DETAILED DESCRIPTION

By attaching non-tangible computer generated products to a code and selling it to a consumer that desires the user of the computer generated interactive program to physically go to a geographic coordinate, creates and additional consumer for the supplier of the non-tangible computer generate product. This method potentially creates an appeal for non-tangible computer generated products to consumers that are not affiliated with a computer generated interactive program.

I claim:

1. A method and system for selling non-tangible computer generated products to consumers that purchase a code that is attached to a geographic location coordinate.

2. The method and system claim 1 wherein the provider creates a desired non-tangible computer generated product that is assigned to a code to be purchased by said consumer.

3. The method and system claim 1 wherein the provider will establish with the consumer a desired geographic location coordinate that the said code will be assigned.

4. The method and system claim 1 wherein the provider then establishes with the consumer a desired non-tangible computer generated product that is attached to a code.

5. The method and system claim 1 wherein the provider then provides the desired code to the consumer whom places the code at the geographic location coordinate.

6. The method and system claim 1 wherein the provider of the computer generated interactive program then makes available to the user of the computer generated interactive program the geographic location coordinate and the desired non-tangible computer generated product that can be obtained at said geographic location.

7. The method and system of claim 6 wherein the user of said computer generated interactive program will then seek out the geographic location coordinate to obtain said code with said computer generated non-tangible product attached.

8. The method and system of claim 6 wherein when said user of computer generated interactive program locates geographic location coordinate will then locate said code at said geographic location coordinate.

9. The method and system of claim 6 wherein the user of the computer generated interactive program being motivated to obtain desired computer generated non-tangible product will then input said code located at the said geographic location coordinate into the desired computer generated interactive program resulting in the receiving of the desired non-tangible computer generated product.

10. The method and system of claim 9 wherein the consumer of said code attached to a non-tangible computer generated product may then interact, per their desire with the user of said computer generated interactive program physically present at the desired geographic location coordinate.
